(19) United States
(12) Patent Application Publication
(10) Pub. No.: US 2007/0267474 A1
(43) Pub. Date: Nov. 22, 2007

(54) SECURE STORAGE DIGITAL KIOSK DISTRIBUTION METHODS

(76) Inventors: Eran Shen, Naharya (IL); Reuven Elhamias, Sunnyvale, CA (US)

Correspondence Address: WINSTON & STRAWN, LLP, PATENT DEPARTMENT, 1700 K STREET, N.W., WASHINGTON, DC, 20006, US

(21) Appl. No.: 11/532,431

(22) Filed: Sep. 15, 2006

Related U.S. Application Data
(63) Continuation-in-part of application No. 11/382,184, filed on May 8, 2006.

(51) Int. Cl. G06F 17/00; G06F 7/08

(52) U.S. Cl. 235/375; 235/381

(57) ABSTRACT

A method and system of providing movies or other content is provided where a flash drive or flash memory card is used in place of DVD's or other formats. A user receives the content on the flash drive from a kiosk. The system ensures that a codec supported by the player of the user will be utilized to encode the content, or in certain embodiments a corresponding codec is provided along with the movie. Authentication and encryption mechanisms ensure that the movie is only provided to an authentic card and/or player from a kiosk, so that the movies cannot be provided to flash devices that do not have proper security mechanisms to safeguard the content or to those not authorized to otherwise receive the movie.

### CROSS REFERENCE TO RELATED APPLICATIONS

The present invention is a continuation-in-part of U.S. patent application Ser. No. 11/382,184 to Eran Shen, entitled “Media with Pluggable Codec,” and filed May 8, 2006; this application is also related to the U.S. application Ser. No. 11/532,420, entitled “Secure Storage Digital Kiosk Distribution,” by Eran Shen and Reuven Elhamias filed concurrently herewith.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### FIELD OF THE INVENTION

The present application is generally related to the usage of flash based mass storage devices for delivering, storing, and reproducing encoded and copy protected movies and other content in a secure fashion.

### BACKGROUND OF THE INVENTION

Traditionally, movies are recorded on a medium such as a DVD or a videocassette, and the movies are then distributed upon the medium. For example, a consumer will travel to a store and rent a movie, or more recently, a DVD containing a movie is mailed to the consumer.

While for quite some time now, although digital content has been available to download over the internet to home computers, the copyright owners of major movies have not allowed the movies to be purchased or rented for home download. This is primarily because of fears of unauthorized duplication and the associated loss of revenue.

While audio files are now available for sale/license to home consumers, these audio files are only a fraction of the size of movies and other large video clips. Thus, the size of video files in comparison to the size of portable storage devices has also provided a hurdle to downloading of movies.

Also, many competing encoding formats for video are available, and there is often a problem decoding video content because it may have been encoded in a format or bit rate that a user's player is not capable of decoding.

### SUMMARY OF INVENTION

According to an embodiment of the present invention, one aspect of the present invention relates to a system and method of supplying content to an individual. A memory card or USB flash drive is received at a (std. or contactless) receptacle of a kiosk for distributing the content. A first verification is then performed, the first verification of the authenticity of the memory card, and occurring while at the receptacle of the kiosk, by comparing first and second keys of an RSA key pair. A second verification is then performed, the second verification of the memory card and the user, by verifying a public key certificate chain issued by a certificate authority. Then if both the first and second verification are successful a container file is created, and a media file is placed in the container file together with a pluggable decoding module. The container file is then transferred from the kiosk to the memory card.

According to another embodiment of the present invention, one aspect of the present invention relates to supplying content to an individual in an encoding format that is supported by a user's player. An indication of one or more encoding formats supported by a player used with the memory card is stored in the memory card when it is connected with the user's player. Then, when the card is connected to a kiosk for distributing the content, a first verification is performed. The first verification is of the authenticity of the memory card and takes place while connected to the kiosk by comparing first and second keys of an RSA key pair. A second verification is then performed, the second verification is of the memory card and the user and involves verifying a public key certificate chain issued by a certificate authority. If both the first and second verification are successful, the content is transferred from the kiosk to the memory card in one or more of the supported content encoding formats. In this way, the problem where the content is provided in a format that cannot be decoded by the user's hardware is eliminated.

### BRIEF DESCRIPTION OF THE DRAWINGS

FIG. 1A is block diagram of distribution and rendering system 5.

FIG. 1B is a schematic diagram of MSD 10 seen in FIG. 1A.

FIG. 1C is a block diagram of authentication entities coupled to network 50.

FIG. 2A is a high level flowchart of a method 200A of providing content according to an embodiment of the present invention.

FIG. 2B is a high level flowchart of a method 200B of providing content according to an embodiment of the present invention.

FIG. 3A is flowchart of a method 300 of providing content according to an embodiment of the present invention.

FIG. 3B is a flowchart of an embodiment of an encryption/decryption process than can be used in the kiosk and card/player.

FIG. 4 is a flowchart illustrating an embodiment of step 230 of FIG. 2A.

FIG. 5 is a schematic diagram illustrating a container file with the media file and the codec file as it is transferred from the kiosk.

FIG. 6 is a flowchart illustrating an embodiment of step 250 of FIG. 2A.

### DETAILED DESCRIPTION OF THE PREFERRED EMBODIMENTS

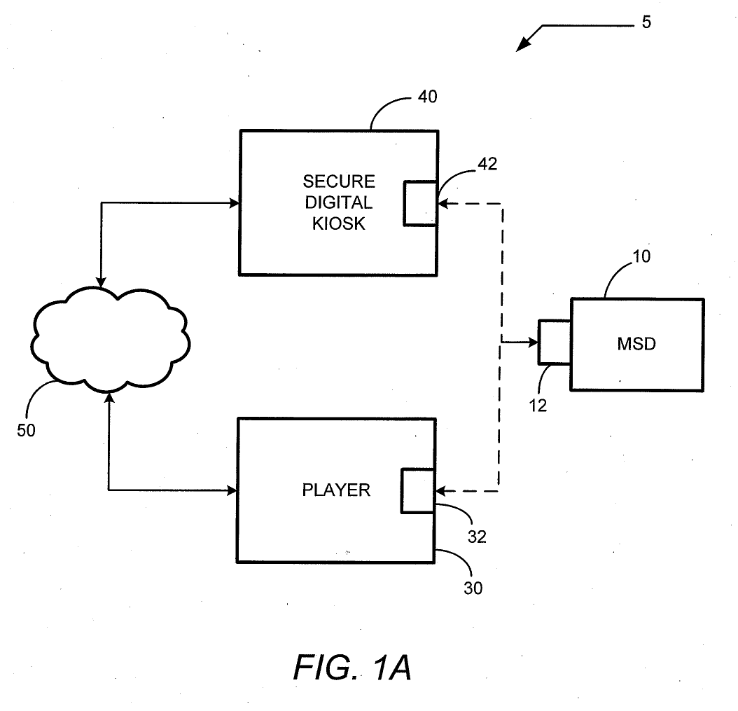

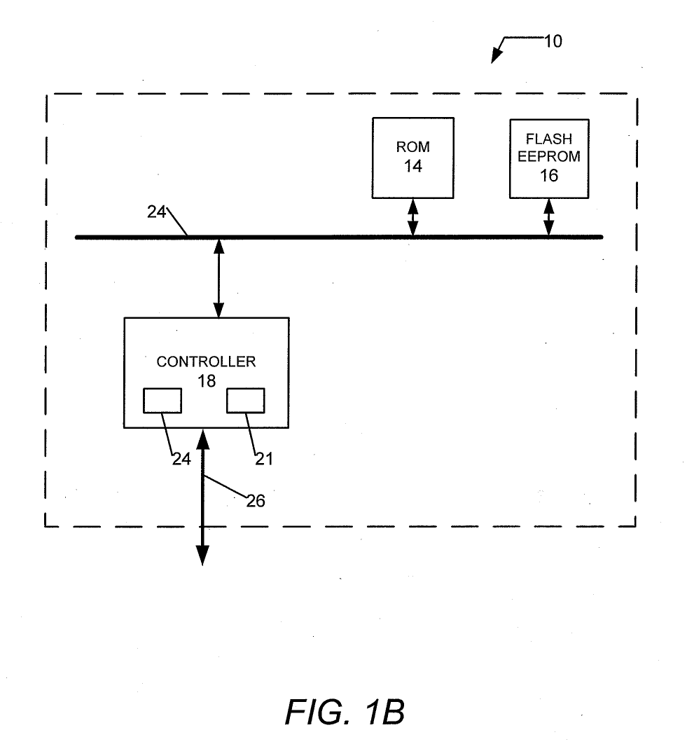

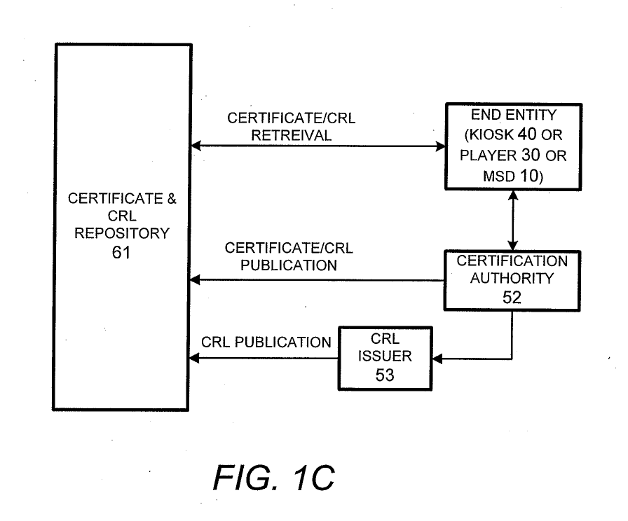

FIG. 1A is block diagram of distribution and rendering system 5. A portable flash memory based mass storage device (“MSD”) 10 is used as a medium to store content received from a secure digital kiosk. MSD 10 may be a memory card or universal serial bus (“USB”) flash drive, and comprises connector 12. There are many well known formats of mass storage memory cards such as the Compact Flash (“CF) Card, Secure Digital (“SD”) Card, Multi Media Card (“MMC”), mini SD card, micro SD card, various forms of memory sticks, XD card etc. For the purposes of this application, the term memory card shall also encompass a USB flash drive. Connector 12 comprises the contacts and contact pattern of a USB connector or memory card depending upon the embodiment. In some embodiments, the kiosk may communicate with the MSD through near field communications (“NFC”) rather than through the connector 12. Kiosk 40 also comprises a compatible connector to receive MSD 10. It therefore also comprises an NFC capable transceiver (not shown).

Kiosk 40 is a distribution point for content. That is to say that someone desirous of content can travel to the kiosk and load the content onto MSD 10. Later, that user can then render or “playback” the content from MSD 10 with player 30. Player 30 also has a connector 32 compatible with connector 12 to interface with MSD 10. Kiosk 40 may comprise conventional computing components such as a microprocessor, display, human interface devices, and storage devices (not shown) but is not a personal computer (“PC”), but rather a publicly available computer, preferably, but not necessarily, dedicated to providing content and performing the transaction for the content, whether as a sale or limited duration license. Thus in certain embodiments, the kiosk may also comprise a credit card reader or means for accepting cash payments, including debits from the MSD itself if it is equipped to act as an “electronic wallet” and carry out transactions.

All media content, when it exists in digital form, whether it be audio or video, is digitally encoded in a particular format. Therefore, in order to play it back or render it, it must be decoded. Often times, the user's player is not capable of decoding content because it does not have the proper decoder, sometimes referred to simply as a codec (coder-decoder). This is not surprising given that there are numerous competing codecs on the market, and the providers of the codecs are in very fierce competition to establish themselves and gain market share at the cost of the other providers. One example is the incompatibility of the Windows Media Player® and Real Player® codecs.

The present invention alleviates this problem, such that material provided by the kiosk 40 to the MSD 10 will always be suitable for playback on or in player 30.

Another problem encountered with digital media content is unauthorized duplication. As can be seen in FIG. 1A, kiosk 40 and player 30 are connected to network 50 which has access to the Internet and various entities that can be accessed via the Internet. Security mechanisms within the kiosk, storage device, and player, as well as the entities accessed via the Internet, will ensure that content is only provided to authorized users and/or devices, as will be described later.

Many consumers already have a flash drive or memory card that they use with a digital camera, music player, PDA, phone or other device that they own. As the capacity of those storage devices has increased, and encoding technology has become much more efficient resulting in smaller file sizes, it is now becoming feasible to encode and store a full length movie in a readily available pocket sized mass storage device.

This will allow the small form factor MSD to become an accepted media for delivering protected content. For instance, movies could be loaded onto MSD 10 rather than on DVD's or video tapes for that matter.

The features of the present invention that assure codec compatibility will increase the ease of use for the consumer, while the security mechanisms will ease the fears of content owners and providers and result in greater availability of copyrighted media for consumers. A new distribution methodology can therefore be established.

FIG. 1B illustrates the main components of an embodiment of MSD 10. MSD 10 comprises a memory controller 18, which controls read/write operations from flash EEPROM 16 via bus 24. An optional ROM 14 may also be included for storage of microcode. Host interface bus 26 communicates with a host device such as kiosk 40 or player 30. In certain embodiments, memory controller 18 comprises a hardware based encryption engine 40 and a firmware integrity circuit 21. These are used, among other things, to encrypt the firmware when it is stored in flash EEPROM 16 and may therefore otherwise be vulnerable to tampering or replacement with fraudulent firmware that circumvents copy protection mechanisms. For more information on this, please refer to U.S. patent application Ser. No. 11/285,600 Hardware Driver Integrity Check Of Memory Card Controller Firmware” to M. Holtzman et al.

For more information on other security mechanisms and techniques present in MSD 100, please refer to the following patent applications and patents, all of which are hereby incorporated by reference in the entirety: “Secure Yet Flexible System Architecture for Secure Devices With Flash Mass Storage Memory” to M. Holtzman et al., application Ser. No. 11/317,339; “Secure Memory Card With Life Cycle Phases” to M. Holtzman et al., application Ser. No. 11/317,862; “In Stream Data Encryption/Decryption and Error Correction Method” to M. Holtzman et al., application Ser. No. 11/313,447; “Control Structure for Versatile Content Control” to F. Jogand-Coulomb et al., application Ser. No. 11/313,536; “System for Creating Control Structure for Versatile Content Control” to F. Jogand-Coulomb et al., application Ser. No. 11/314,055; “Mobile Memory System for Secure Storage and Delivery of Media Content” to B. Qawami et al., application Ser. No. 11/322,766; and “In Stream Data Encryption/Decryption Method” to M. Holtzman et al., application Ser. No. 11/314,030.

Certain embodiments of the MSD may also comprise NFC circuitry including and NFC controller and antenna in order to transmit data with various hosts without using the contacts of the MSD. For further information on incorporation of NFC hardware in MSD 100, please refer to U.S. patent application Ser. No. 11/321,833 to F. Jogand Coulomb, entitled “Methods Used in a Nested Memory System With Near Field Communications Capability.”

FIG. 1C is a block diagram of authentication entities coupled to network 50. In a public key infrastructure (“PKI”), arrangements enable users to be authenticated to each other, and to use the information in identity certificates (i.e., each other's public keys) to encrypt and decrypt messages travelling to and fro. The foundation or framework for the PKI is defined in the ITU-T X.509 Recommendation which is incorporated by this reference it is entirety.

In general, a PKI consists of client software, server software such as a certificate authority, hardware and operational procedures. A user may digitally sign messages using his private key, and another user can check that signature (using the public key contained in that user's certificate issued by a certificate authority within the PKI). This enables two (or more) communicating parties to establish confidentiality, message integrity and user authentication without having to exchange any secret information in advance.

FIG. 1C shows one possible implementation of the embodiment that utilizes the public key infrastructure for verification/authorization of credentials. End Entities are sometimes thought of as end-users. Although this is often the case, the term End Entity is meant to be much more generic. An End Entity can be an end-user, a device such as a router or a server, a process, or anything that can be identified in the subject name of a public key certificate. End Entities can also be thought of as consumers of the PKI-related services. In the present invention, as seen in the embodiment shown in FIG. 1C, the end entity may be any of: mass storage device 10, alone or together with player 30; player 30; and kiosk 40 or users of any of these pieces of hardware.

Public keys are distributed in the form of public key certificates by CA 52. In some embodiments, a certificate may be required from MSD 10 before KIOSK 40 or validating entity would allow a user of MSD 10 to receive content from KIOSK 40. Public key certificates are digitally signed by the issuing CA 53 (which effectively binds the subject name to the public key) and stored in repository 61. CAs are also responsible for issuing certificate revocation lists (“CRLs”) unless this has been delegated to a separate CRL Issuer. CAs may also be involved in a number of administrative tasks such as end-user registration, but these are often delegated to a separate registration authority (“RA”) which is optional and not shown in FIG. 1C. In practice, CA 52 or another CA can also serve as the key backup and recovery facility although this function can also be delegated to a separate component. CAs are often thought of as the “source of trust” in a PKI. Typically, End Entities are configured with one or more “trust anchors” which are then used as the starting point to validate a given certification path. Once trust is established via the PKI interface between kiosk 40 and MSD 10, alone or in combination with player 30, loading into the MSD can take place. PKI authentication between MSD 10 and player 30 may also be required in some embodiments before rendering or playback can take place.

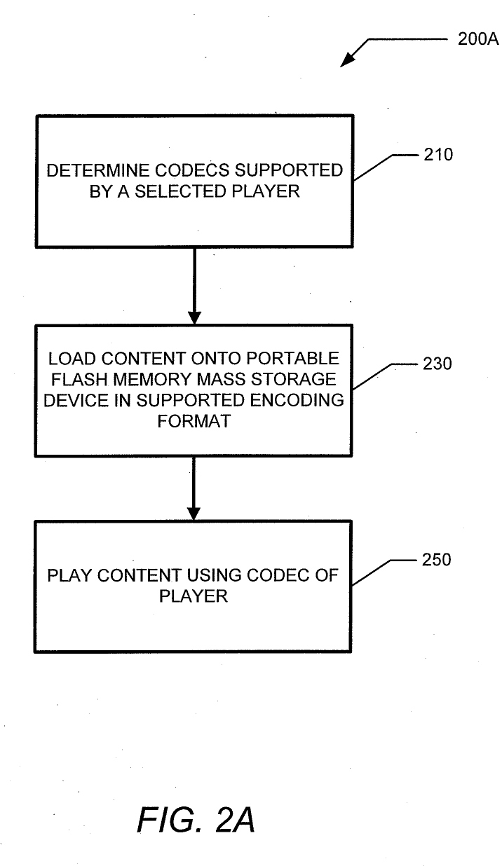

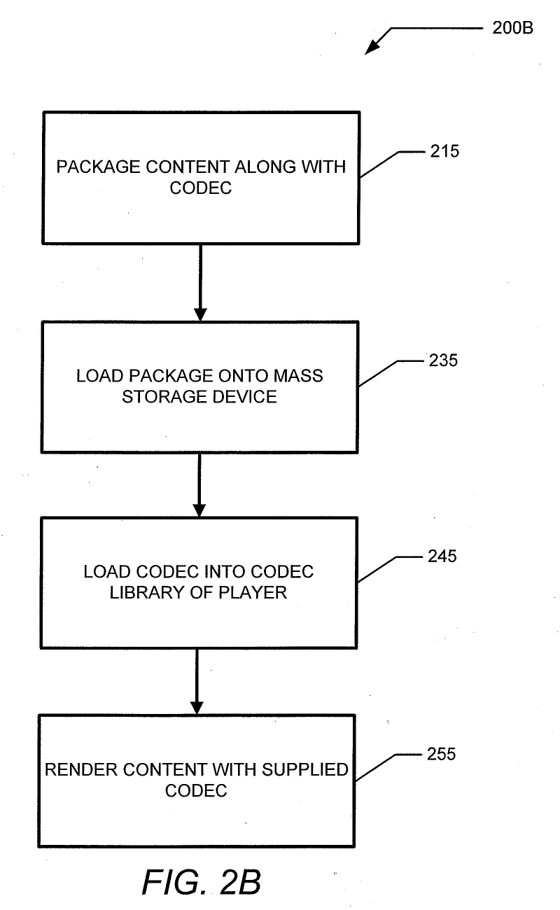

FIG. 2A is a flowchart of method 200A. In step 210, the codecs supported by a user's player are determined. The player can be instructed, through menus of the player, to save an indication of the supported codecs to the card. Then an indication of the supported codecs is written to the mass storage device. Next, in step 230, the user selected content is loaded into the portable flash mass storage device in one of the supported encoding formats, as determined in step 210. The MSD will be loaded into or otherwise connected to the kiosk when this takes place. The stored indication will be read by the kiosk in order to select the proper encoding format for the content. Next in step 250, when the MSD is coupled or inserted into the player, the content on the MSD will be rendered (decoded) using the appropriate codec. Alternatively, the content can first be copied to a memory of the player, and decoded from that memory, given that the player and card have mutually authenticated each other and determined that the player has adequate copy protection safeguards.

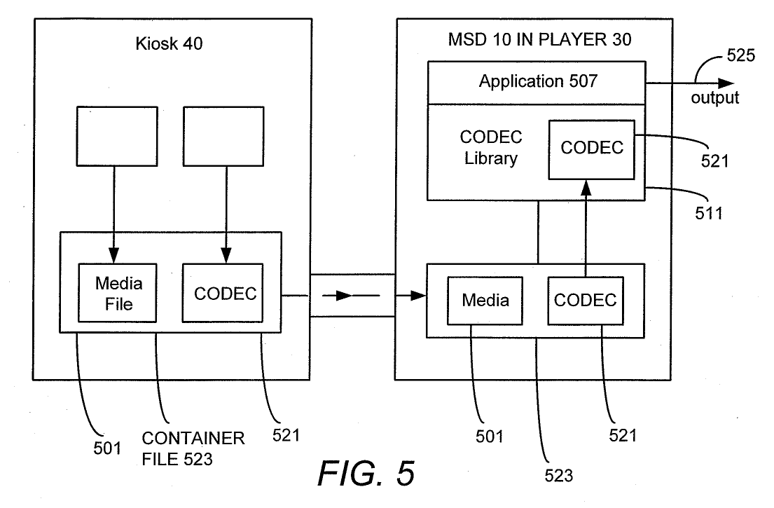

FIG. 2B is a flowchart of method 200B, according to another embodiment of the present invention. In step 215, content encoded in a given format will be packaged with the appropriate codec required to later decode it when playback is desired. In this way, the situation where the player does not have the proper decoder to decode the encoded content is avoided. In step 235, the packaged content and codec are loaded into the mass storage device. Next, in step 245, the codec is transferred from the mass storage device into the player and stored in the appropriate location so that it may be accessed as necessary. This is preferably in a library of a media player application and will be described below in more detail with regard to FIG. 5. The content itself may also be transferred to a memory of the player at this time, if as mentioned above, the player has the proper security mechanisms and is authenticated. Finally, in step 255, the content is decoded and rendered with the decoder of the supplied codec.

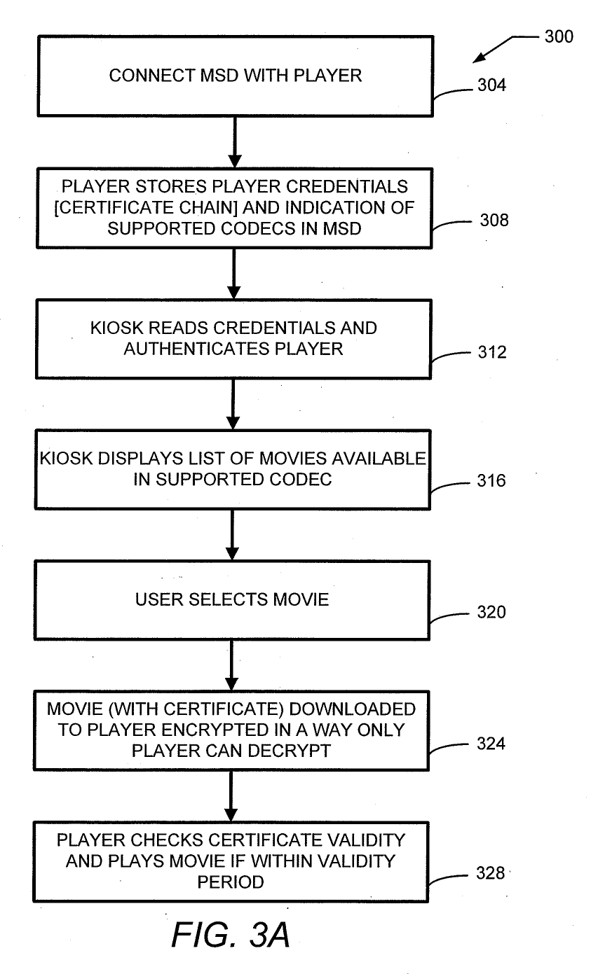

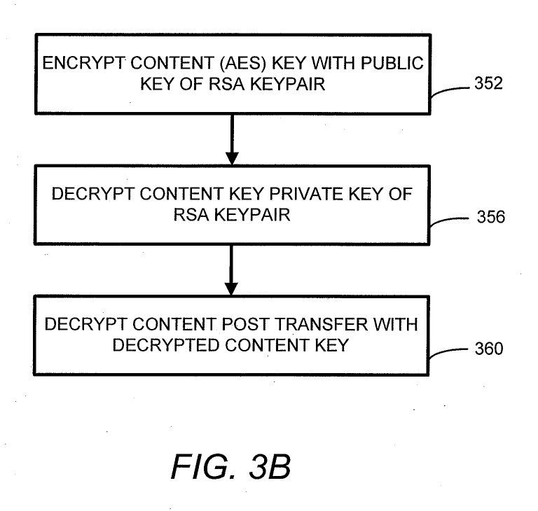

FIG. 3A is a flowchart of method 300. In step 304, the user connects the MSD with a player, typically by plugging the MSD into a receptacle of the player. As mentioned earlier, connection may alternatively be through near field communications. Next, in step 308, the player stores its credentials, preferably in the form of a certificate chain, along with an indication of the codecs supported by the player, in a memory of the MSD. The player may also store the bit rates that it supports. For example, it may store an indication that it supports the MP4 video format at bit rates up to 60 fps and/or the MP3 audio format at bit rates up to 128 kbps. Once the MSD is coupled with the kiosk the kiosk reads the player credentials stored in the card and authenticates the player. If the player is not authenticated, the process will not go forward, in order to avoid providing content to a source that may duplicate or distribute the content in an unauthorized manner.

If however, in step 312 the player is authenticated, i.e. the certificate chain is verified, the process will then go forward. In step 316, the kiosk will then display a list of movies available in the codec supported by the player. In the case where the bit rate information is stored in the card, the list will preferably contain movies that can be provided at the appropriate bit rate. In order to do this it reads an indication of the supported codecs/formats from the memory of the MSD. In step 320, the user then selects the movie(s) he wishes to receive (rent or buy) from the kiosk. Next, in step 324, the selected movie(s) are downloaded to the player encrypted in a way only the player can decipher or decrypt. Preferably, the file containing the movie is encrypted using the public key of the player. A certificate is also provided with the movie and loaded into the MSD. The certificate preferably includes an indication of the validity period of the movie. For example, the movie may only be playable for a finite period of time (e.g. 90 days) from the date it was loaded into the MSD. Finally, in step 328, the player checks the certificate validity and plays the movie if within the validity period.

FIG. 3B is a flowchart of an embodiment of an encryption/decryption process than can be used in the kiosk and card/player. In step 352, the content is encrypted with a product of the RSA key pair. Preferably, an AES content key is encrypted with the public key of the RSA key pair. This occurs on the kiosk side. Then after the encrypted content is transferred to the MSD, the content key is decrypted with the private key of the RSA key pair in step 356. Once this takes, place, in step 360 the content itself is decrypted with the decrypted content key.

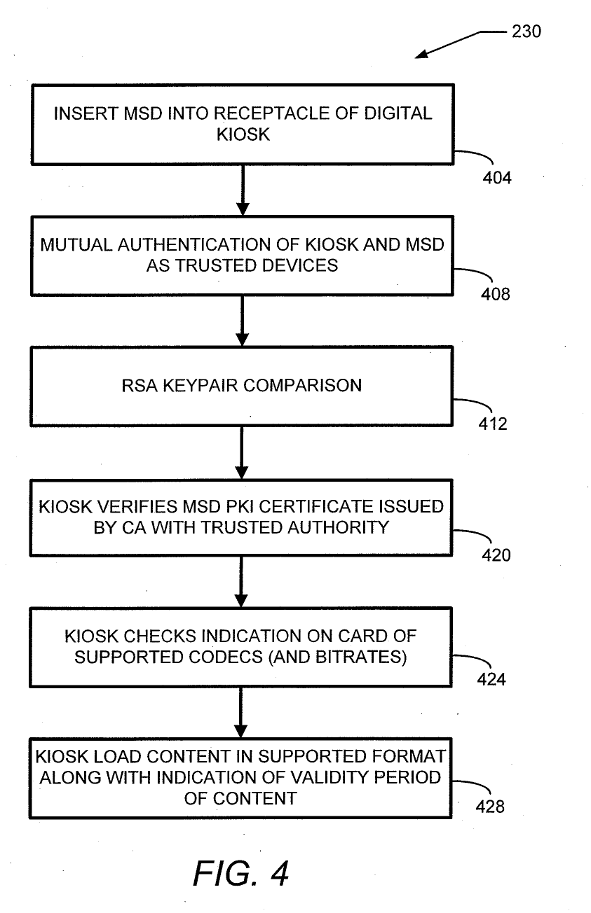

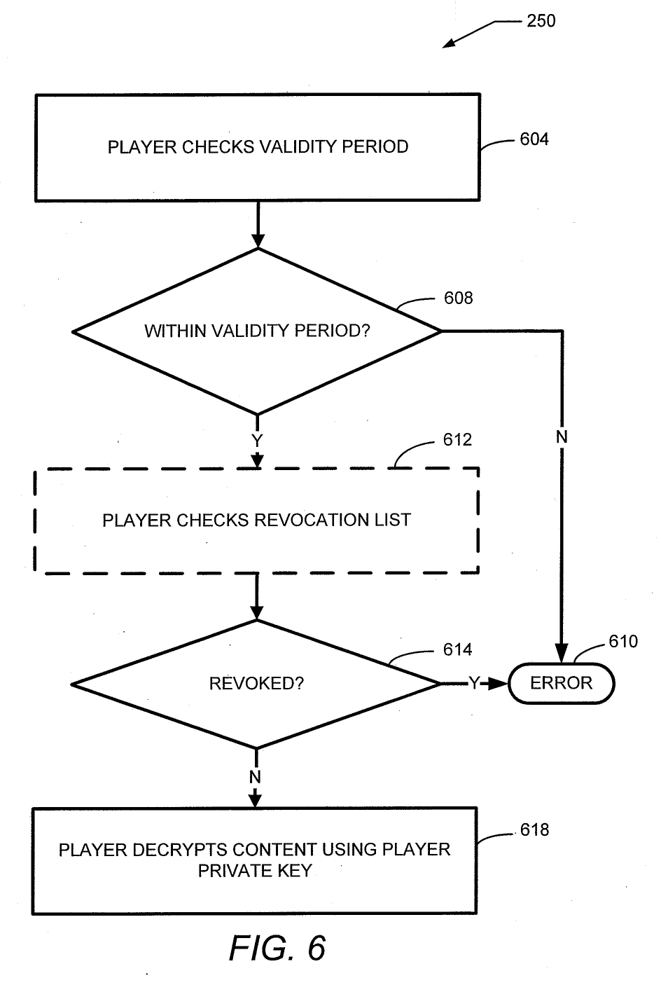

FIG. 4 is a flowchart illustrating one embodiment of step 230 of FIG. 2A. In step 404, the user inserts the MSD into a receptacle of the digital kiosk. Then, in step 408, the kiosk and MSD mutually authenticate each other as trusted devices. Step 408 is optional and is performed according to the well known SD card authentication protocol, in embodiments where the MSD employs the SD protocol. Next in step 412, RSA keys of the MSD and kiosk are compared. Of course, before they are compared they would have been stored in each of the respective devices. If the RSA keypair comparison is not successful, then the process will terminate. If a match is determined, the process will proceed to step 420, and the kiosk will verify the MSD certificate by accessing a trusted authority (e.g. CA 52 or repository 61). In step 424, the kiosk will then check the indication on the MSD of the supported codecs, and the preferred bit rates if present. Steps 408, 412, and 420 may all be considered authentication processes. Then, in step 428, the kiosk will load the content in the supported format, and at a preferred bit rate if such indication was present, along with an indication of the validity period of the content, into the MSD. In some embodiments, the kiosk may also check a certificate revocation list to ensure that the certificate of the MSD has not been revoked, as will be discussed later with regard to FIG. 6.

FIG. 5 is a schematic diagram illustrating a container file with the media file and the codec file as it is transferred from the kiosk in some embodiments. Within kiosk 40, the content, whether it be a movie or some other type of content, will be in the form of a media file. The media file 501 will be placed in container file 523. The media file will be encoded, as mentioned earlier, in a specific format dependent upon what type of encoder was utilized to encode the media file. The codec 521 necessary to decode the media file 501 is also placed in container file 523. The container file 523 is then loaded into MSD 10, which is eventually placed in player 30. Codec 521, which is preferably a plug-in type codec is then transferred to the code library 511 of media application 507. Media application 507 is the software application of player 30 that is used to render or play back content, and optionally to encode content depending upon the nature of player 30. For example, a device 30 capable of recording audio or video would also include an encoder to digitally encode the content before it is recorded. Application 507 outputs the content which is eventually reproduced by a screen and/or speakers of device 30, or devices coupled thereto, as represented by arrow 525.

FIG. 6 illustrates one possible embodiment of steps that may take place as part or playing content, as depicted in step 250 of FIG. 2A. In step 604, the player checks the validity period of the content the user wishes to play. In step 608, the player then checks if the content is still within the validity period. If it is not, in step 610, an error condition will be present and may be displayed to the user. If, however, the content is still within the validity period, in step 612, the player optionally checks a certificate revocation list. The revocation list may be stored in a memory of the player or MSD, or if the player has access to the Internet, it may be instantaneously checked with a trusted authority. If, as seen in step 614, the certificate of the content has been revoked, the player will not play the content, but an error condition will again be present and indicated as represented by step 610. If, however, the certificate has not been revoked, in step 618 the player will decrypt the content using a private key of the player.

Although the various aspects of the present invention have been described with respect to exemplary embodiments thereof, it will be understood that the present invention is entitled to protection within the full scope of the appended claims.

It is claimed:

1. A method of supplying content to an individual, the method comprising:
receiving a memory card in a receptacle of a kiosk for distributing the content;
performing a first verification, the first verification of the authenticity of the memory card, and occurring while in the receptacle of the kiosk, by comparing first and second keys of an RSA key pair;
performing a second verification, the second verification of the memory card and the user, by verifying a public key certificate chain issued by a certificate authority, and if both the first and second verification are successful, thereafter,
creating a container file;
placing the content within a media file in the container file;
placing a pluggable decoding module in the container file; and
transferring the container file from the kiosk to the memory card.

2. The method of claim 1, further comprising storing the RSA key pair, a first key of the key pair in the kiosk and a second key of the key pair in the memory card or a player used with the memory card.

3. The method of claim 1, wherein a public key of the public key certificate is stored in the memory card by the player.

4. The method of claim 3, wherein the transferred content is encrypted using the public key of the player.

5. The method of claim 4, wherein the transferred content is encrypted using a key of the kiosk.

6. The method of claim 1, further comprising receiving payment at the kiosk for the content.

7. The method of claim 1, further comprising checking a validity period of the content, and if playback of the content is requested during the validity period, playing the content on the card.

8. The method of claim 4, further comprising checking a validity period of the content, and decrypting the content with a private key of the player if playback of the content is requested during the validity period, but not if the content is requested outside of the validity period.

9. A method of supplying digitally encoded content to an individual, the method comprising:
storing, in a memory of a transportable flash memory mass storage device, an indication of the encoding formats supported by a player for use with the mass storage device;
monitoring, for an insertion of the mass storage device within a receptacle of a digital kiosk, and when insertion is detected;
performing a first verification, the first verification of the mass storage device, and occurring while in the receptacle of the kiosk, by comparing first and second keys of an RSA key pair;
performing a second verification, the second verification of a player of the user, by verifying a public key certificate chain issued by a certificate authority, and if both the first and second verification are successful, transferring, from the kiosk to the mass storage device, the content in one or more of the supported content encoding formats; and
performing a third verification, the third verification taking place while the mass storage device is coupled to the player, the third verification verifying that content selected for playback is within a validity period associated with the content.

10. The method of claim 9 further comprising encrypting the content prior to transfer with a product of the RSA key pair.

11. The method of claim 9 wherein the product comprises a content key encrypted with a public key of the RSA keypair.

12. The method of claim 10, further comprising decrypting the content post transfer with a product of the RSA key pair.

13. The method of claim 11, further comprising decrypting the content key with a private key of the RSA keypair.

14. The method of claim 13, further comprising decrypting the content post transfer with the decrypted content key.

15. A method of supplying content to an individual, the method comprising:
storing, in a memory of a memory card, an indication of one or more encoding formats supported by a player used with the memory card;
receiving the memory card in a receptacle of a kiosk for distributing the content;
performing a first verification, the first verification of the authenticity of the memory card, and occurring while in the receptacle of the kiosk, by comparing first and second keys of an RSA key pair;
performing a second verification, the second verification of the memory card and the user, by verifying a public key certificate chain issued by a certificate authority; and,
if both the first and second verification are successful, transferring, from the kiosk to the memory card, the content in one or more of the supported content encoding formats.

16. The method of claim 15, further comprising storing the RSA key pair, a first key of the key pair in the kiosk and a second key of the key pair in the player or the memory card.

17. The method of claim 15, wherein a public key of the public key certificate is stored in the memory card by the player.

18. The method of claim 17, wherein the transferred content is encrypted using the public key of the player.

19. The method of claim 18, wherein the transferred content is encrypted using a key of the kiosk.

20. The method of claim 15, further comprising receiving payment at the kiosk for the content.

21. The method of claim 15, further comprising transferring an indication of the validity period of the content, from the kiosk to the card.

22. The method of claim 21, further comprising checking the validity period of the content, and if playback of the content is requested during the validity period, playing the content on the card.

23. The method of claim 21, further comprising checking the validity period of the content, and decrypting the content with a private key of the player if playback of the content is requested during the validity period.

24. The method of claim 15, wherein the card is a micro SD card format or an SD card format.
